(19) United States
(12) Patent Application Publication
(10) Pub. No.: US 2015/0083670 A1
(43) Pub. Date: Mar. 26, 2015

(54) ROTATING AQUEOUS HARVESTER

(71) Applicant: Doug Jackson, Klamath Falls, OR (US)

(72) Inventor: Doug Jackson, Klamath Falls, OR (US)

(21) Appl. No.: 14/489,098

(22) Filed: Sep. 17, 2014

Related U.S. Application Data
(60) Provisional application No. 61/882,183, filed on Sep. 25, 2013.

(51) Int. Cl. E02B 15/10; C02F 1/00

(52) U.S. Cl. CPC E02B 15/103; C02F 1/001; C02F 2303/16; C02F 2103/007
USPC 210/747.6; 210/391; 210/170.05

(57) ABSTRACT

An aqueous harvester is disclosed that utilizes a rotating drum having a mesh surface to collect material from a body of water. The drum is operative to rotate, typically as the drum is propelled through water by a watercraft. Material collecting on the mesh surface below the water line is rotated out of the water. The material is removed from the mesh surface by spraying pressurized water through the mesh surface into a catch trough disposed within the drum. The material is then removed from the catch trough for further processing.

### CROSS REFERENCE

This application claims the benefit of the filing date of U.S. Provisional Application No. 61/882,183 having a filing date of Sep. 25, 2013, the entire contents of which is incorporated herein by reference.

### FIELD

The present disclosure relates to a system for separating material from an aqueous medium. More specifically, the present disclosure relates to selectively separating material from a body of water.

### BACKGROUND

In number of applications, it is desirable to separate material from an aqueous medium (e.g., body of water). For instance, aquatic plants, such as kelp and algae, or animals, such as daphnia, are sometimes collected from bodies of water. Collection of such aquatic organisms may be for differing purposes. In some instances, such aquatic plants may be collected for the purpose of cleaning the body of water. In other instance, such aquatic plants are harvested for the purpose of subsequent consumption by humans and/or animals. In further instances, aquatic plants are harvested for use in personal care products and nutritional supplements. Other applications where materials are separated from a body of water include removal of contaminants (e.g., oil, trash, etc.) and the harvesting of materials (e.g., specific algae) for subsequent bio-fuel processing.

The separation of material from a body of water is often performed using specialized craft that move over the surface of the body of water. Such crafts may skim materials from the surface or drag “drapers” with screens through a body of water to strain suspended material from the water. Other crafts may utilize a collector mounted toward the bow of craft where the collector is pushed through the water. Often, such collection craft (e.g., harvesters) are specially designed pontoons or barges.

Existing harvesters are often non-selective when extracting material from a body of water. That is, all material in the body of water that contacts the collector is collected and undesired materials must be subsequently removed.

### SUMMARY

Provided herein is an aqueous harvester that utilizes a mesh surface to capture material on and/or below the surface of a body of water and continually lift the material out of the water. Once material disposed on the mesh surface is lifted out of the water, pressurized fluid (e.g., air or water) may be utilized to remove the material from the mesh surface. In one arrangement, spacings in the mesh surface are sized to selectively extract material from the body of water.

According to a first aspect, an apparatus is provided for extracting material from a body of water that includes a substantially cylindrical drum having a mesh surface. This drum is configured to rotate when partially disposed within the water. In this regard, materials to be extracted from the body of water physically engage strands of the mesh surface and are rotated out of the water. In one arrangement, spacing of strands forming the mesh surface allow for capturing high aspect ratio materials (e.g., fibers) while more obloid materials pass through the mesh surface. An actuator rotates the drum while disposed within the water. Such rotation may occur while the drum is stationary and located in moving water (e.g., in a river). Alternatively, such rotation may occur while the cylindrical drum is propelled through the water, for instance, as supported by watercraft. In any arrangement, once the material is collected on the mesh surface, it must be removed from this mesh surface. In the present arrangement, the catch trough is disposed within the cylindrical drum and extends over at least a portion of its length. A source of pressurized fluid, such as a spray bar, is disposed outside of the cylindrical drum. The pressurized fluid is utilized to direct a fluid stream through the mesh surface and into the catch trough. The stream pressurized fluid removes material from the mesh surface and disposes that material into the catch trough. This material and water may then be removed from the catch trough for further processing.

In one arrangement, the cylindrical drum may be selectively deployed into the body of water and retracted from the body of water. In this regard, a watercraft carrying such a cylindrical drum may remove the drum from the water when not collecting material.

In another aspect, a method is provided for extracting material from a body of water. The method includes rotating at least partially submerged mesh surface in a body of water. In one arrangement, the mesh surface is the outside surface of a partially submerged drum or cylindrical body. At least a portion of the mesh surface is disposed above the surface of the water. Material adhering to the mesh surface above the surface of the water is removed utilizing a pressurized fluid stream that sprays through the mesh surface. The material removed from the mesh surface is captured such that the material may be further processed. In one arrangement, the method includes collecting strand material on the mesh surface while allowing obloid materials to pass through the mesh surface. That is, strand material may be selectively collected free of other materials.

### BRIEF DESCRIPTION OF THE DRAWINGS

FIG. 1A illustrates a side view of an exemplary water craft with one embodiment of a rotating collecting apparatus in a retracted position.

FIG. 1B illustrates a side view of the water craft with the rotating collecting apparatus in a deployed position.

FIG. 1C illustrates a partial top view of the watercraft.

FIG. 2 illustrates perspective view of a collecting drum.

FIG. 3 illustrates a perspective view of a frame of the collecting drum.

FIG. 4 illustrate collection of strand material utilizing a mesh surface.

FIG. 5 illustrates a partial end view of the collecting drum and removal of material from the surface of the drum.

FIG. 6 illustrates an exemplary support and rotation mechanism for the collecting drum.

FIG. 7 illustrates an alternate rotation mechanism for the collecting drum.

FIG. 8 illustrates a perspective view of another embodiment of a rotating collecting apparatus.

FIG. 9 illustrates an end view of the rotating collecting apparatus of FIG. 8.

### DETAILED DESCRIPTION

Reference will now be made to the accompanying drawings, which at least assist in illustrating the various pertinent features of the present invention. The following description is presented for purposes of illustration and description and is not intended to limit the invention to the form disclosed herein. Consequently, variations and modifications commensurate with the following teachings, and skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

The following describes embodiments of apparatus for and methods of extracting material from a body of liquid, such as, for example, extracting algae or surface contaminants from a body of water. Some embodiments described below are described in the context of selectively extracting strands of Aphanizomenon flos-aquae (AFA) from a body of water, although these embodiments (and this disclosure) are not limited to this context. That is, different types of algae as well of other materials may be extracted using the systems, apparatuses and methods disclosed herein.

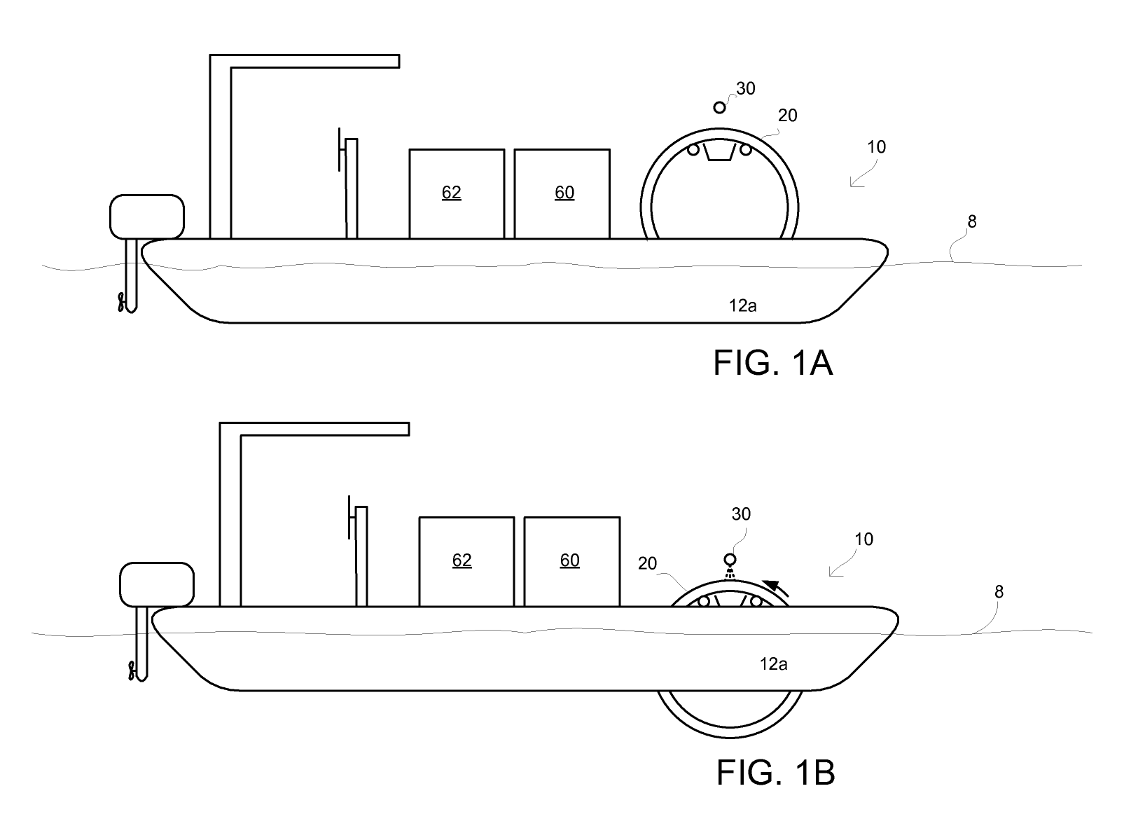

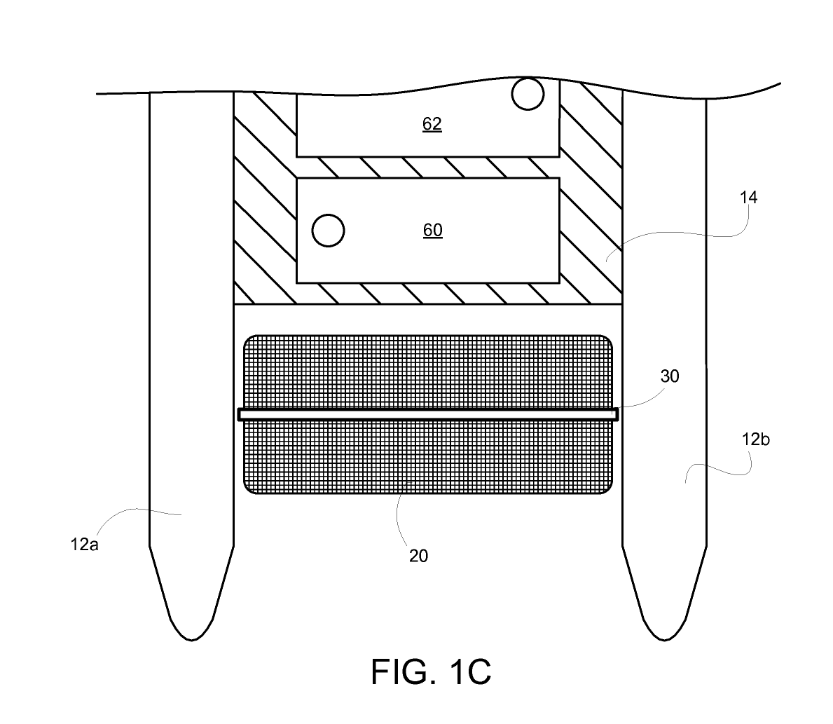

FIGS. 1A, 1B and 1C illustrate one embodiment of an apparatus 10 for extracting material from a body of water. The apparatus 10 can be used as a harvester for extracting biomass, such as algae, from a body of water. The apparatus 10, in the illustrated embodiment, is a self-propelled watercraft that supports a first embodiment of a rotating collecting apparatus, which in the present embedment is a collecting drum 20, proximate to a forward end or bow of the craft. In the illustrated embodiment, the craft is a pontoon boat having first and second pontoons 12a and 12b. See FIG. 1C. The pontoons 12a, 12b may be constructed from sealed cylinders such as pipes or barrels. However, it will be appreciated that aspects of the presented inventions may be utilized with other watercraft including other self-propelled/motorized and non-motorized crafts.

In the present embodiment, a deck 14 extends between the pontoons 12a, 12b and provides a platform onto which various components may be mounted. As illustrated in FIG. 1C, the collecting drum 20 is disposed between the pontoons 12a, 12b. Though illustrated as being located toward the bow of the craft, it will be appreciated that the collecting drum may be located at other locations such as the center or rear of the craft. In the present embodiment, the collecting drum 20 may be selectively positioned into and out of the water. Specifically, as shown in FIG. 1A, the a majority or the entirety of the collecting drum 20 may be raised above the surface of the water 8 to allow for movement of the craft free of any drag from the collecting drum 20. When it is desired to collect material from the body of water, the collecting drum 20 may be lowered into the water 8 as illustrated in FIG. 1B.

As shown in FIG. 1B, at least a portion of the collecting drum 20 remains above the surface of the water 8 during use. Further, the collecting drum 20 is operative to rotate against the forward movement of the watercraft as illustrated by the arrow in FIG. 1B. However, will be appreciated that the collecting drum may rotate in either direction (i.e., clockwise or counterclockwise). Once disposed within the water, material within the water contacts the portion of the collecting drum 20 that is disposed below the surface of the water. In addition, the drum 20 may be propelled through the water by the watercraft. The speed of such propulsion through the water and/or rotation of the drum may depend upon the material being removed from the water.

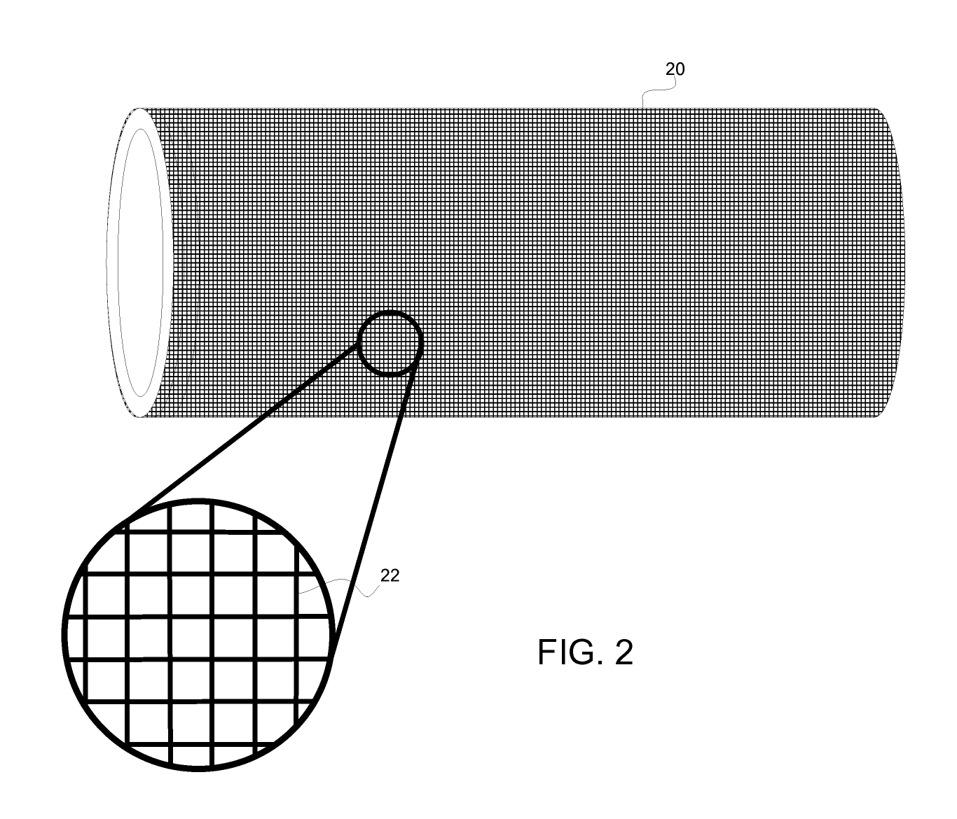

In the present embodiment, the collecting drum 20 has a porous surface that allows water to flow through its surface and through the interior of the drum 20. More specifically, the surface of the drum has a mesh surface 22 as illustrated in FIG. 2. The mesh surface 22 consists of semi-permeable barrier made of connected strands of metal, fiber, or other flexible/ductile material. The mesh can be woven, knitted, welded, expanded, photo-chemically etched or electroformed (screen filter) from steel or other metals.

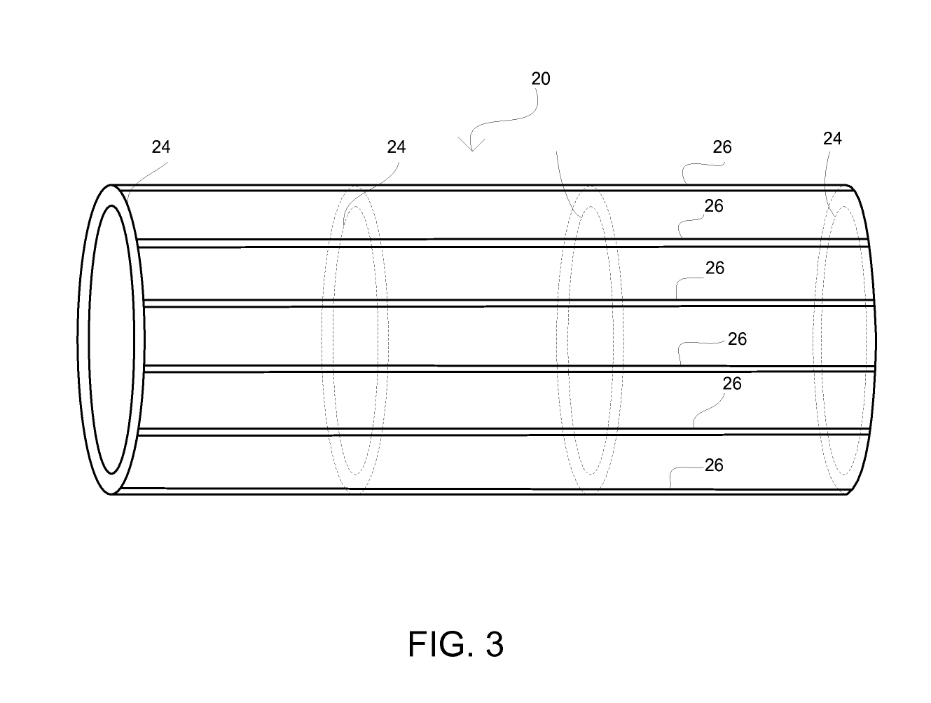

FIG. 3 illustrates the drum 20 with the mesh surface removed. As shown, the drum 20 includes a plurality of annular rims 24 that support crossbeams 26 about their peripheries. The mesh surface 22 is fixedly interconnected to the cross beams 26 as shown in FIG. 2. The mesh surface 22 may be attached to the crossbeams 26 in any appropriate manner. In one embodiment, the mesh surface is riveted to the crossbeams. However, this is not a requirement.

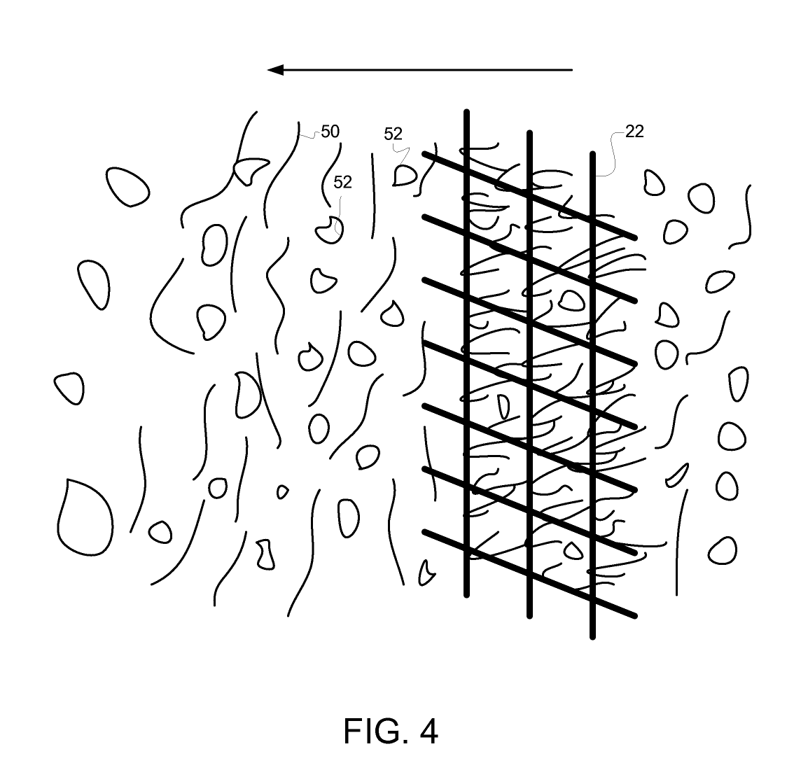

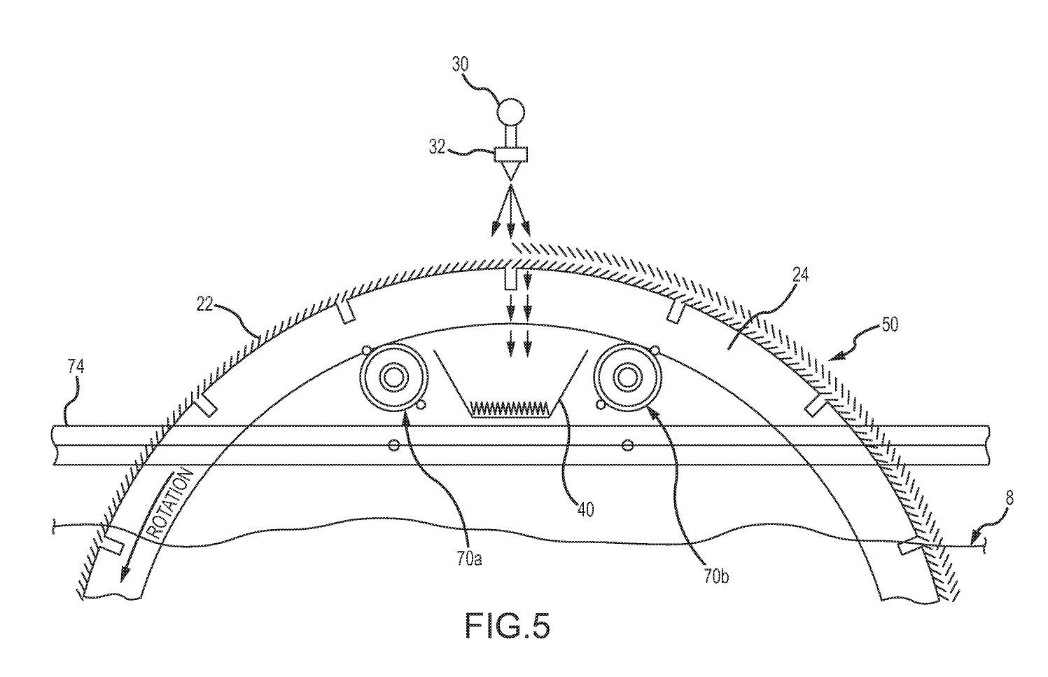

Use of the mesh surface 22 allows for selectively collecting material from a body of water. Specifically, by selecting a specific spacing of the mesh strands, it has been determined that materials may be selectively removed from a body of water. For instance, when harvesting AFA, which is also sometimes referred to as microalgae, it is common for additional types of algae to exist in the body of water containing the AFA. It is desirable to remove the AFA from the body of water free of these other materials. Along these lines, it has been recognized that AFA is typically an elongated strand in its natural form. For instance, AFA commonly has strands with a length of between about five and 20,000 microns (approximately 2 cm). Further, such strands have a very narrow width or thickness. Stated otherwise, AFA strands have large aspect ratios where their length is many times their width/thickness. In contrast, many other materials, e.g., other algae, that exist in conjunction with AFA are often irregular spherical in shape (i.e., obloid shapes). That is, such materials have an aspect ratio that is closer to 1:1. By passing these different materials through a mesh surface 22, strand materials (e.g., AFA) may be separated from the more obloid materials. This is illustrated in FIG. 4. As shown, when the mesh surface 22 moves through water containing both strand materials 50 (e.g., AFA) and obloid materials 52, the strand materials 50 due to their large aspect ratios drape over and around the strands of the mesh surface 22. In contrast, obloid materials 52 pass through the mesh surface 22. Accordingly, the strand materials 50 may be removed from the water (i.e., with rotation of the drum supporting the mesh surface 22) free of most of the obloid materials.

It has been further recognized that increasing the spacing of the mesh surface 22 results in increased collection of strand material. For instance, in the case of AFA having a strand size between about five and 20,000 microns, it has been found that mesh surfaces having a ⅛ inch to 3/16 inch spacing significantly increases collection AFA in comparison with mesh surfaces having spacing of less than 1/16 of an inch. Specifically it has been determined that utilizing a larger mesh spacing allows for increased fluid flow through the mesh surface 22. This increased flow allows for more strand material within the water to contact and drape over the mesh strands. Stated otherwise, mesh surfaces having a smaller spacing results in reduced fluid flow through the mesh surface due to the creation of a fluid boundary on such a smaller mesh surface. This fluid boundary effectively pushes water and materials within the water away from the mesh surface as the it proceeds through the water. Accordingly, mesh spacings between about ⅛ of an inch and about one inch are believed to provide the greatest collection of AFA strand material from water. That is, smaller spacings inhibit fluid flow and reduce the amount of AFA that contact mesh surface while larger spacings detrimentally reduce the contact area of the mesh surface. However, it will be appreciated that other mesh spacings may be utilized for other strand materials. Specifically, it is believed that longer strand materials may utilize larger mesh spacings.

Once the strand material is draped over the mesh surface as illustrated in FIG. 4, the majority of the strand material will remain in contact with the mesh surface 22 as it is rotated out of the water. That is, strand material that collects on the submerged portion of the mesh surface 22 is removed from the water as the drum 20 rotates. This stand material is then removed from the mesh surface 22 of the drum 20 utilizing a spray bar 30 having one or more nozzles 32 that are disposed above the drum 20. See FIGS. 1B and 5. The spray bar 30 provides a pressurized stream of water that forces the strand material off of the mesh surface 22. Specifically, the pressurized water stream is directed from an outside surface of the rotating drum 20 toward and inside surface of the rotating drum 20. A receiving or catch trough 40 is disposed within the interior of the rotating drum 20 opposite of the spray bar 30 and spray nozzle(s) 32. The catch trough 40 is located proximate to an upper portion of the drum 20 such that it remains above the surface of the water 8 when the drum 20 is deployed in the water to collect material.

Upon contact with the pressurized water stream, the strand material and water is received within the catch trough 40. The resulting slurry of strand material and water may be removed from the trough (e.g., pumped) and stored within a tank 60 on the craft. Further, the slurry may be at least partially dewatered utilizing one or more methods known to those skilled in the art.

The water for the spray bar 30 may originate from another tank 62 on the craft or may originate from the body of water. In the latter regard, it will be appreciated that filters may be utilized to precondition the water prior to use in removing the strand material from the mesh surface 22.

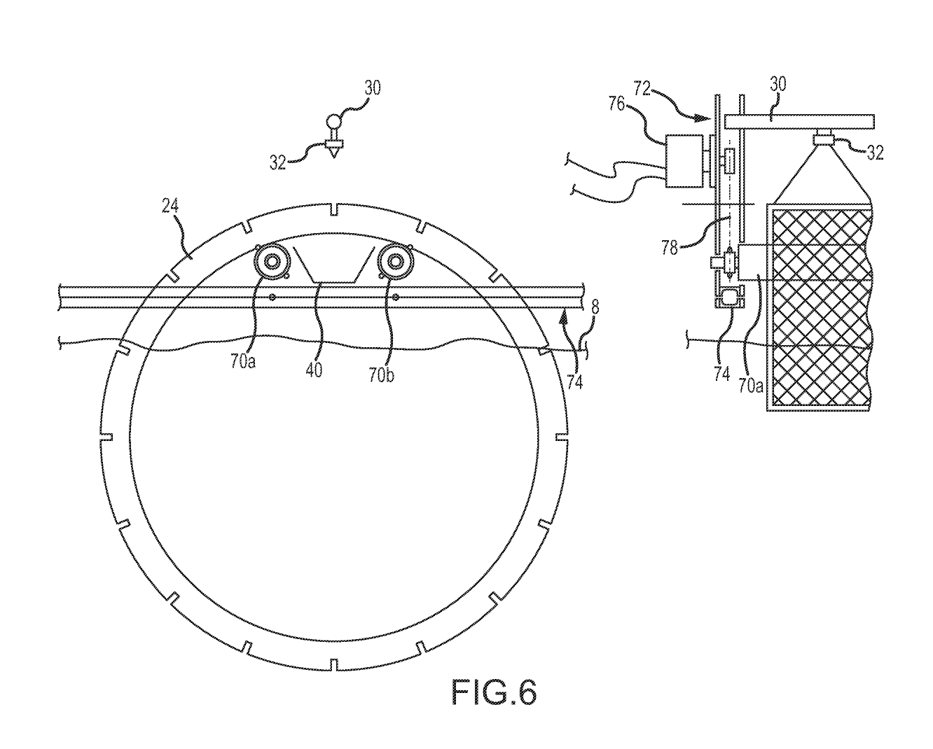

Various mechanical connections may be utilized to mount the rotating drum 22 the craft as well as raise and lower the drum. However, it will be appreciated that in other embodiments, the drum may be statically attached to the craft without the ability to raise and lower. Likewise, various different configurations may be utilized to rotate the drum 20. In one embodiment, the collecting drum 20 is supported by first and second rollers 70a, 70b that extend across the width of the drum 20. The outside surfaces of the rollers 70a, 70b rest on the inside surfaces of the rims 24 of the rotating drum 20. This is best illustrated in FIGS. 5 and 6. As shown in FIG. 6, the rollers 70a, 70b are rotably supported by end plates 72 (only one shown). Further, the end plates support opposing ends of the spray bar. The end plates are fixedly connected to support bars 74 (only one shown) or frame. This frame may be attached to appropriate mechanism (e.g., hydraulic cylinders) that allow for raising and lowering the drum. In the present embodiment, a first actuator 76 (e.g., hydraulic motor) supported by one of the end plates is operatively connected to at least one of the rollers 70a in order to turn the roller 70a and thereby rotate the drum 20. In one embodiment, a sprocket on an output shaft of a hydraulic motor 76 is connected to a sprocket attached to the roller 70a or to sprockets attached to both rollers. In this embodiment, a chain 78 interconnects the sprockets. It will be appreciated that other mechanisms may be utilized. In the present embodiment, the use of the rollers 70a, 70b disposed toward the top of the drum 20 and above the water line 8 allows for providing a rotating force to the drum without the rollers and or actuator/motor being disposed within the water.

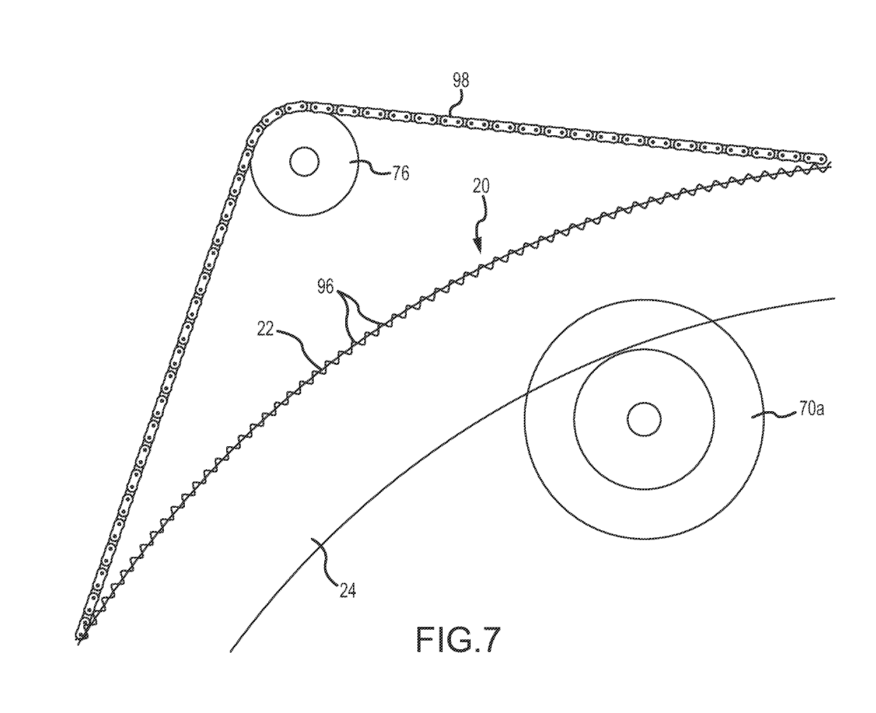

FIG. 7 illustrates an alternate embodiment of a mechanism for rotating the drum 20. In this embodiment, one of the end rims 24 includes a geared outer surface 96. That is, the end rim effectively defines a sprocket. In this arrangement, the actuator 76 includes a mating gear/sprocket that is physically connected to the outer surface of the rim 24 via a chain 98. In another embodiment, a smaller sprocket may be attached to a center axis of the drum. Further, in other embodiments, the chain may be omitted and an actuator gear may directly engage a mating gear of the cylinder. In any of these embodiments, the drum is physically coupled to the actuator, which may reduce or prevent slippage of the drum, during heavy loading.

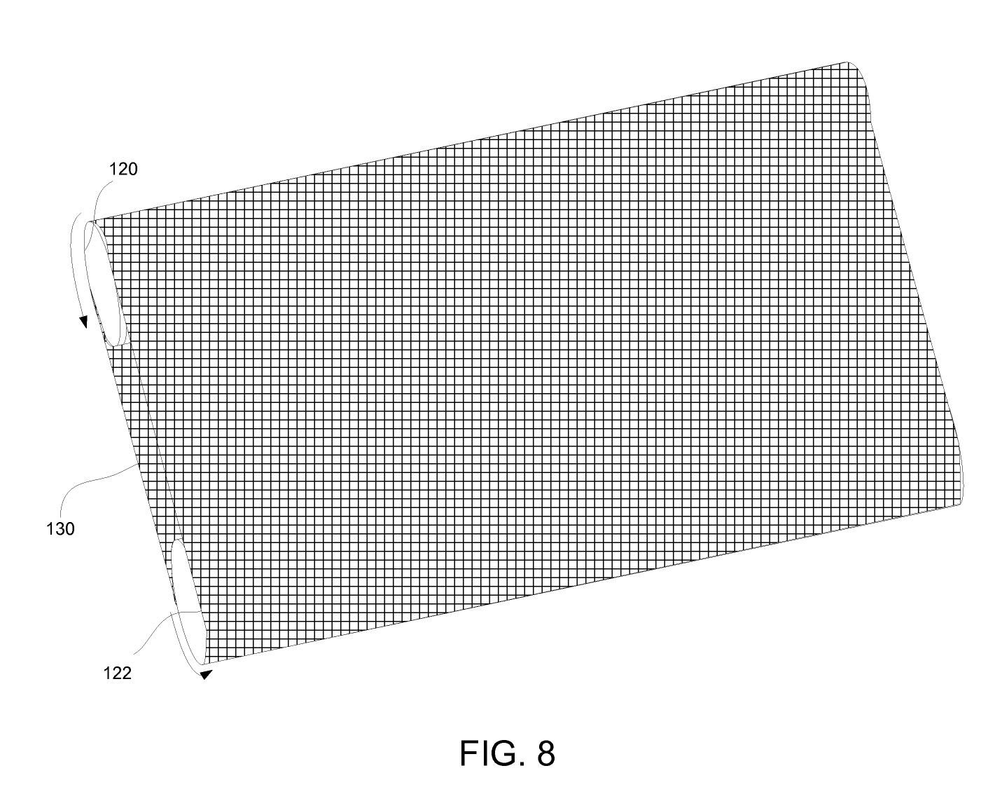

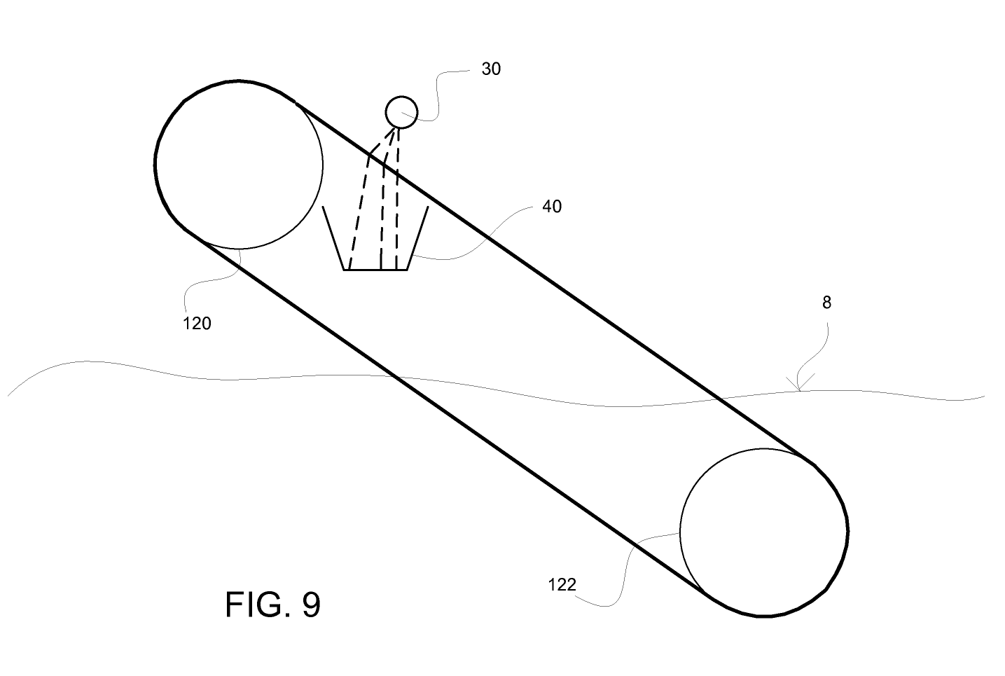

FIGS. 8 and 9 illustrate another embodiment of a rotating collecting apparatus in accordance with various aspects of the present disclosure. As shown, in this embodiment, the rotating collecting apparatus includes first and second rollers 120, 122 and a mesh surface 130 (e.g., screen) that extends between and around the rollers. In this embodiment, one or both of the rollers 122 is operative to be controllably rotated to rotate the mesh surface 130. In this embedment, a lower roller (e.g., roller 122) may be disposed beneath the surface of the water 8 during operation. Again, material may be collected on the submerged portion of the mesh surface. Once engaged on the mesh surface, rotation of the mesh surface removes the material from the water. A spray bar 30 disposed above the waterline 8 provides a water stream through the mesh surface 30 and into a collecting trough 40, which is disposed between the rollers 120, 122 and between opposing surfaces of the mesh surface. Again, the resulting slurry of material and water may be stored to a tank and/or dewatered.

The foregoing description has been presented for purposes of illustration and description. Furthermore, the description is not intended to limit the inventions and/or aspects of the inventions to the forms disclosed herein. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. An apparatus for extracting material from a body of water, comprising:
a substantially cylindrical drum having a mesh surface configured to rotate when at least partially disposed in water, wherein a material to be extracted from the body of water adheres to the mesh surface;
an actuator operative to rotate said drum;
a catch trough disposed within said cylindrical drum and extending over at least a portion of a length of the cylinder between first and second ends of the cylinder; and
a source of pressurized water, wherein said source is disposed outside of said cylindrical drum and is configured to direct a stream of water through said mesh surface and into said catch trough, wherein said stream of water removes the material from the mesh surface and deposits said material into said catch trough.

2. The apparatus of claim 1, wherein said mesh surface comprises a set of transverse strands, wherein a minimum spacing between said strands is at least ⅛ of an inch.

3. The apparatus of claim 2, wherein said minimum spacing is at least 3/16 of a inch.

4. The apparatus of claim 1, further comprising:
a watercraft supporting said drum.

5. The apparatus of claim 4, wherein said watercraft is configured to move said drum between a deployed position where a portion of said drum is below a water surface and a retracted position where a majority of said drum is above the water surface.

6. The apparatus of claim 5, wherein said catch trough and said source of pressurized water are positioned above the water surface when the drum is deployed.

7. The apparatus of claim 4, wherein said actuator is operative to rotate said drum in a direction opposite of a direction of movement of said watercraft.

8. The apparatus of claim 1, further comprising:
at least one roller extending through at least a portion of an interior of said drum, wherein said drum is at least partially supported by said at least one roller.

9. The apparatus of claim 8, wherein said actuator is operative to rotate said roller, wherein rotation of said roller rotates said drum.

10. The apparatus of claim 1, further comprising a gear fixedly connected to said drum, wherein said actuator engages said gear to rotate said drum.

11. The apparatus of claim 1, wherein said source of pressurized water comprises a spray bar disposed over a length of an outside surface of said drum.

12. A method for extracting material from a body of water, comprising:
rotating a partially submerged drum having a mesh surface in a body of water having a material to be extracted from the body of water;
applying a pressurized stream of water to an outside surface of said drum on a portion of the drum above the water line;
catching the stream of water and material removed from the mesh surface by the stream of water in a receptacle disposed within the drum, wherein the receptacle is above a water line of the body of water.

13. The method of claim 12, further comprising:
in conjunction with rotating said drum, propelling said drum through said body of water.

14. The method of claim 12, further comprising:
removing said material from said receptacle.

15. The method of claim 14, further comprising:
at least partially dewatering said material upon removal from said receptacle.

16. The method of claim 12, further comprising:
collecting strand material on said mesh surface, wherein said strand material is collected at least partially free of obloid material in said body of water passing through said mesh surface.

17. The method of claim 12, further comprising:
sizing a spacing of said mesh surface selectively collect material of greater than a predetermined aspect ratio and allow material of less than said aspect ratio to pass through said mesh.

18. An apparatus for extracting material from a body of water, comprising:
first and second rollers,
a continuous mesh surface extending around the outside surfaces of the rollers and configured to rotate when at least partially disposed in water, wherein a material to be extracted from the body of water adheres to the mesh surface;
an actuator operative to rotate at least one of said rollers to rotate said mesh surface;
a catch trough disposed between said first and second rollers and between opposing surfaces of said mesh surface; and
a source of pressurized water, wherein said source is disposed outside of said mesh surface is configured to direct a stream of water through said mesh surface and into said catch trough, wherein said stream of water removes the material from the mesh surface and deposits said material into said catch trough.

19. The apparatus of claim 18, further comprising:
a watercraft supporting said first and second rollers and said continuous mesh, wherein said watercraft is configured to move said continuous mesh between a deployed position where a portion of said continuous mesh is below a water surface and a retracted position where a majority of said continuous mesh is above the water surface.
